(19) United States
(12) Patent Application Publication
(10) Pub. No.: US 2009/0100220 A1
(43) Pub. Date: Apr. 16, 2009

(54) Memory system, control method thereof and computer system

(75) Inventor: Kazuhiko Kajigaya, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Elpida Memory, Inc., Tokyo (JP)

(21) Appl. No.: 12/285,745

(22) Filed: Oct. 14, 2008

(30) Foreign Application Priority Data
Oct. 15, 2007 (JP) 2007-268419

(51) Int. Cl. G06F 12/00

(52) U.S. Cl. 711/109; 711/154; 711/E12.001

(57) ABSTRACT

A memory system includes a memory cell array for storing data; and a register unit including one or more registers for storing system information. In the memory system, when a simultaneous access to the memory cell array and the register unit is requested, write data for the memory cell array is inputted after write data for the register unit is inputted, respectively through a common data input bus in a write operation, and read data from the memory cell array is outputted after read data from the register unit is outputted, respectively through a common data output bus in a read operation.

### BACKGROUND OF THE INVENTION

1. Field of the Invention

The present invention relates to a memory system having a memory cell array which stores data for information processing, and particularly relates to a memory system having a configuration for storing system information used for controlling an operating system or the like in a register unit provided separately from the memory cell array.

2. Description of Related Art

In recent years, an operating system adopting multi-thread or multi-core has become widely used in order to handle parallel processing in a computer system. In such a computer system controlled by the operating system, control information transmitted between different threads or different cores, flags used in preferential exclusive control for assigning resources to processors, or the like are stored as common information in a predetermined storage area of a common memory. When the number of threads to be processed simultaneously or the number of existing cores increases, a situation occurs in which the common information is accessed frequently, thereby rapidly increasing the number of accesses to the above storage area. The access to the common information is generally given priority over accesses to a memory for normal information processing. Therefore, latencies for accessing normal data increases in order to ensure the latency for accessing the common information, thereby lowering overall process efficiency in the computer system.

Meanwhile, various methods for improving the process efficiency in the computer system handling parallel processing have been conventionally proposed. For example, Patent Reference 1 discloses a technique for improving efficiency of multi-thread processing in a multi-thread computer system by eliminating accesses to a common main memory which are required in the exclusive control. For example, the Patent Reference 2 disclose a technique including a method for monitoring accesses to a cache memory in a common memory system with a multi-processor for the purpose of preventing efficiency reduction of the processor due to idle running of a spin loop which occurs by frequently accessing the common memory system to obtain an exclusive authority. Otherwise, many proposals have been made for the purpose of improving the process efficiency in the computer system handling parallel processing.

Patent Reference 1: Japanese Patent Publication No. 3546694

Patent Reference 2: Laid-open Japanese Patent Publication No. 2006-155204

However, the both techniques disclosed in the Patent References 1 and 2 with respect to the above conventional computer system are measures limited to an exclusive control function associated with the parallel processing, and cannot be applied to a control requiring accesses to other common memories. Further, in the technique disclosed in the Patent Reference 1, when the number of processor elements increases, the frequency of communications between the processor elements increases, thereby possibly causing a bottleneck. Furthermore, since a circuit block added to the processor elements is required, area penalty inevitably increases when the number of processor elements increases. Meanwhile, in the technique disclosed in the Patent Reference 2, there is a problem that it cannot be applied to a system without a cache memory, for example, a processor for an embedded system.

### SUMMARY

The present invention seeks to solve the above problem and provides a memory system in which a register unit is provided separately from a memory cell array so as to access the memory cell array and the register unit simultaneously through a common data input/output bus, for the purpose of improving process efficiency of a computer system handling parallel processing without adding a new bus configuration.

In one of aspects of the invention, there is provided a memory system having a memory cell array for storing data and a register unit including one or more registers for storing system information. In this memory system, when a simultaneous access to the memory cell array and the register unit is requested, write data for the memory cell array is inputted after write data for the register unit is inputted, respectively through a common data input bus in a write operation, and read data from the memory cell array is outputted after read data from the register unit is outputted, respectively through a common data output bus in a read operation.

According to the aspects of the invention, when accessing both the memory cell array for storing data and the register unit for storing system information, a control is performed so that data for the register unit is inputted/outputted firstly and input/output data for the memory cell array is inputted/outputted subsequently, respectively through the common data input (output) bus in both the write and read operations. Thus, since a latency of the register unit of small scale is generally shorter than a latency of the memory cell array of large scale, it is possible to perform efficient data input/output operations without hindering each other by commonly using the data bus. Accordingly, even when common information and the like required for the parallel processing is frequently accessed, an increase in unnecessary memory accesses can be avoided, and the processing ability of the entire system can be improved without providing complex hardware.

Further, in one of aspects of the invention, there is provided a control method of a memory cell array for storing data and a register unit including one or more registers for storing system information, comprising the steps of: setting a state in an operation mode for accessing the memory cell array and the register unit simultaneously; inputting write data for the memory cell array after inputting write data for the register unit, respectively through a common data input bus when performing a write operation; and outputting read data from the memory cell array after outputting read data from the register unit, respectively through a common data output bus when performing a read operation.

Furthermore, in one of aspects of the invention, there is provided a computer system comprising: the above memory system according; and a multi-core processor including a plurality of processor cores and a control block for controlling an access to the memory cell array and the register unit respectively through a bus.

As described above, according to the present invention, when a memory system is implemented as a part of a computer system adopting multi-thread or multi-core, a control is performed for the purpose of accessing both a memory cell array for storing data and a register unit for storing system information such as common information. In the control, the system information in the register unit is inputted/outputted firstly and data in the memory cell array is inputted/outputted subsequently, respectively through a common data bus. In this manner, since data input/output operations can be performed in a proper order by utilizing the fact that a latency of the memory cell array of large scale is longer than a latency of the register unit of small scale, it is possible to prevent a decrease in process efficiency caused by a bottleneck of memory accesses. Further, a predetermined operation can be performed in background by an operation circuit performing an operation by using the common information and the like stored in the register unit, in the above described access operation, and thus the process efficiency of the system can be further improved. By configuring such a memory system, the conventional bus configuration can be used without providing a special control circuit, and therefore the process efficiency of the entire system can be improved using a simple hardware without an increase in cost.

### BRIEF DESCRIPTION OF THE DRAWINGS

The above features and advantages of the present invention will be more apparent from the following description of certain preferred embodiments taken in conjunction with the accompanying drawings, in which:

FIG. 1 is a block diagram showing an entire configuration of a memory system 1 of an embodiment;

FIG. 2 is a diagram showing address configuration and data input/output configuration of the memory system 1 of the embodiment;

FIG. 3 is a diagram showing an example of a list of command sets for the memory system 1;

FIG. 4 is a diagram showing an example of a list of operation designation codes attached to command codes of FIG. 3;

FIG. 5 is a diagram showing operation waveforms when a memory cell array 11 is accessed in the memory system 1;

FIG. 6 is a diagram showing operation waveforms when a register file 12 is accessed in the memory system 1;

FIG. 7 is a diagram showing operation waveforms when the memory cell array 11 and the register file 12 are accessed simultaneously in the memory system 1;

FIG. 8 is a diagram showing a first example of a computer system including the memory system 1 of the embodiment; and

FIG. 9 is a diagram showing a second example of a computer system including the memory system 1 of the embodiment.

### DETAILED DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes. In the following, an embodiment of a memory system configured to store system information such as common information required for parallel processing in an operating system.

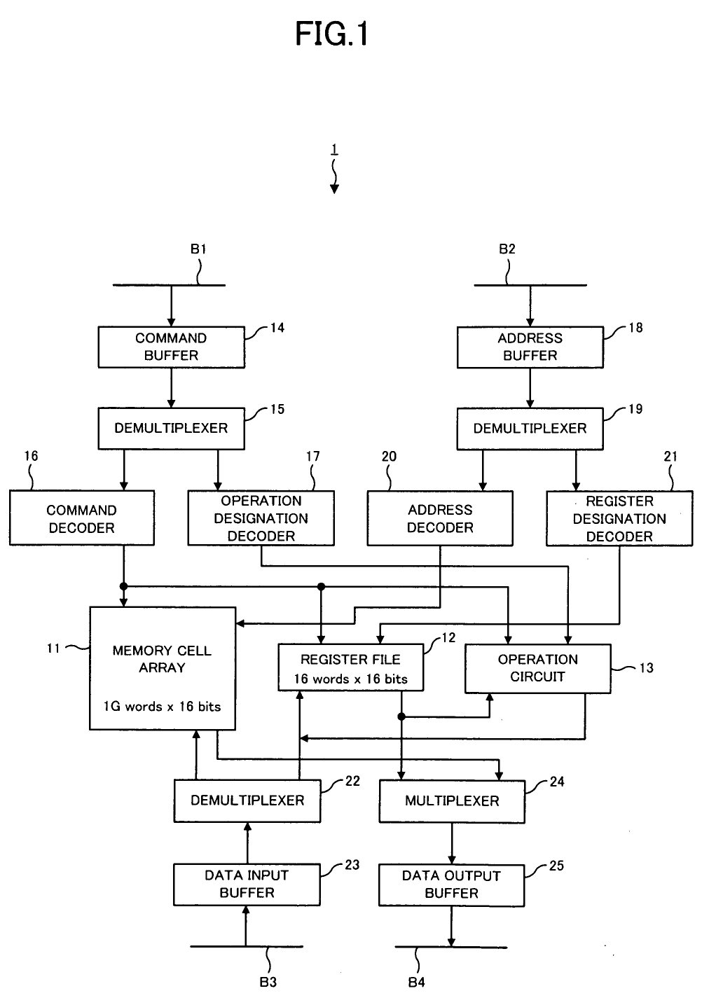

FIG. 1 is a block diagram showing an entire configuration of a memory system 1 of the embodiment. As shown in FIG. 1, the memory system 1 of the embodiment includes a memory cell array 11, a register file 12, an operation circuit 13, a command buffer 14, demultiplexers 15, 19 and 22, a command decoder 16, an operation designation decoder 17, an address buffer 18, an address decoder 20, a register designation decoder 21, a data input buffer 23, a multiplexer 24, and a data output buffer 25.

The memory cell array 11 is composed of many memory cells for storing data used in normal information processing, and has a memory space of, for example, 1 G words×16 bits (2 G Byte). The register file 12 is a group of registers for storing system information of the operating system and functions as the register unit of the invention. The register file 12 has a configuration of, for example, 16 words×16 bits (16 registers). In this manner, the memory cell array 11 and the register file 12 are configured to have a common bit width (16 bits). Meanwhile, the operation circuit 13 is a circuit for performing an operation designated when the register file 12 is accessed. Here, an operation mode for accessing the memory cell array 11 and the register file 12 separately, and an operation mode for accessing them simultaneously can be set for the memory system 1 of the embodiment, which will be described in detail later.

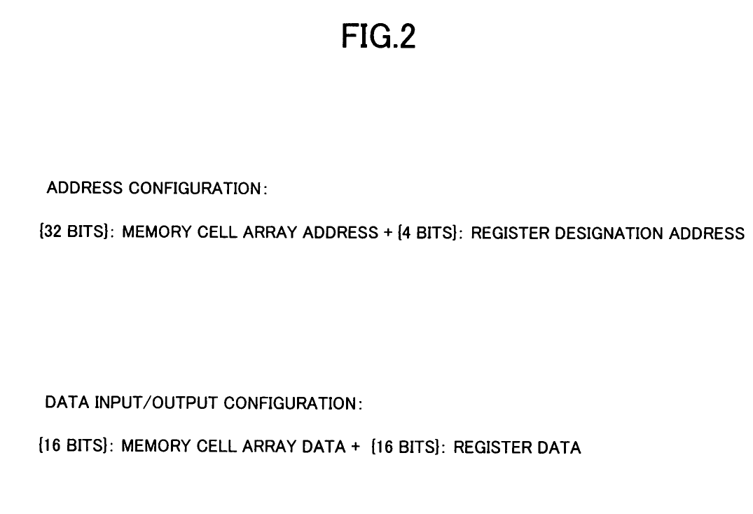

In FIG. 2, there are shown an address configuration and data input/output configuration of the memory system 1 of the embodiment. The address configuration shown in FIG. 2 includes a 32-bit memory cell array address for designating an address space of the memory cell array 11, and four-bit register designation information (register number) for selecting a certain register of the register file 12 (36 bits in total). Further, the data input/output configuration shown in FIG. 2 includes 16-bit memory cell array data and 16-bit register data (32 bits in total), since it is assumed that both the memory cell array 11 and the register file 12 have the bit width of 16 bits.

The command buffer 14 is connected to a command bus B1 of 4-bit width. When receiving a predetermined command for controlling the memory system 1, a four-bit command code and a four-bit operation designation code are sequentially inputted in time division through the command bus B1 to the command buffer 14. The command stored in the command buffer 14 is outputted to the demultiplexer 15, and after the command code and the operation designation code are extracted respectively, the command code is sent to the command decoder 16 while the operation designation code is sent to the operation designation decoder 17.

Meanwhile, the address buffer 18 is connected to an address bus B2 of 32-bit width. When receiving an address for accessing the memory system 1, a 32-bit memory cell array address designating a memory cell of the memory cell array 11 and a four-bit register number specifying a register of the register file 12 are sequentially inputted in time division through the address bus B2 to the address buffer 18. The address stored in the address buffer 18 is outputted to the demultiplexer 19, and after the memory cell array address and the register number are extracted respectively, the memory cell array address is sent to the address decoder 20 while the register number is sent to the register designation decoder 21.

Read and write operations for the memory cell array 11 and read and write operations for the register file 12 are controlled in response to the command decoded by the command decoder 16. At this point, the memory cell accessed in the memory cell array 11 is designated based on the memory cell array address inputted to the address decoder 20, and the register accessed in the register file 12 is designated based on the register number inputted to the register designation decoder 21. Further, data of the designated register in the register file 12 is inputted to the operation circuit 13. The operation circuit 13 performs each of predetermined operations corresponding to the operation designation code stored in the operation designation decoder 17, and the operation result is outputted to the designated register in the register file 12.

The data input buffer 23 is connected to a data input bus B3 of 16-bit width. When receiving write data from outside, 16-bit data for the memory cell array 11 and 16-bit data for the register file 12 are sequentially inputted in time division through the data bus B3 to the data input buffer 23. The data stored in the data input buffer 23 is sent to the demultiplexer 22. Among the data inputted to the demultiplexer 22, write data of one word (16 bits) for the memory cell array 11 is extracted and write data of one word (16 bits) for the register file 12 is extracted.

Read data of one word (16 bits) from the memory cell array 11 and read data of one word (16 bits) from the register file 12 are inputted to the multiplexer 24, respectively. The input data becomes serial in the multiplexer 24, and 32-bit data is sent to the data output buffer 25. The data output buffer 25 is connected to a 16-bit width data output bus B4, and data from the multiplexer 24 is outputted in time division through the data output bus B4 to outside.

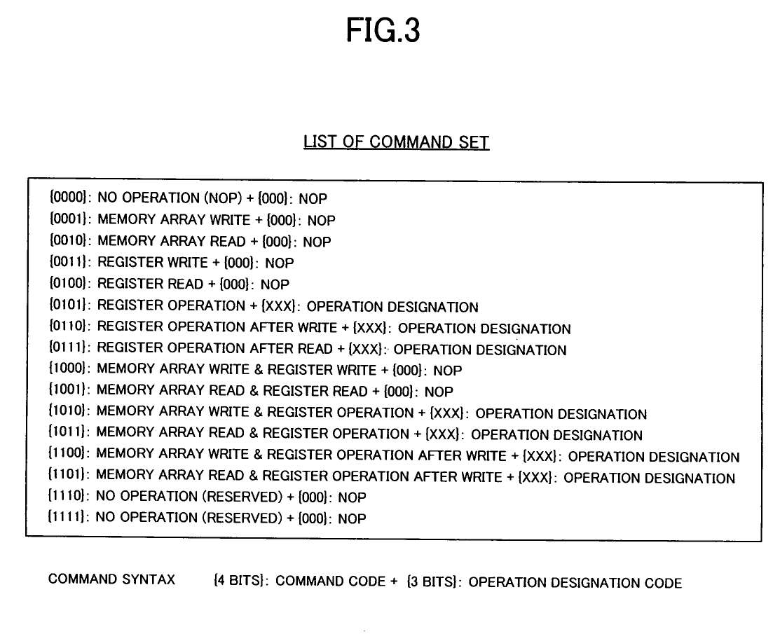

Next, command sets defining various commands used for controlling the memory system 1 will be described with respect to FIG. 3. FIG. 3 shows an example of a list of the command sets for the memory system 1, which includes a plurality of commands each composed of a four-bit command code and a three-bit operation designation code. The command codes defined by the command sets includes a command code {0000} representing no operation (NOP), command codes {0001} and {0010} each representing an access only to the memory cell array 11, command codes {0011} to {0111} each representing an access only to the register file 12, and command codes {1000} to {1101} each representing a simultaneous access to the memory cell array 11 and the register file 12.

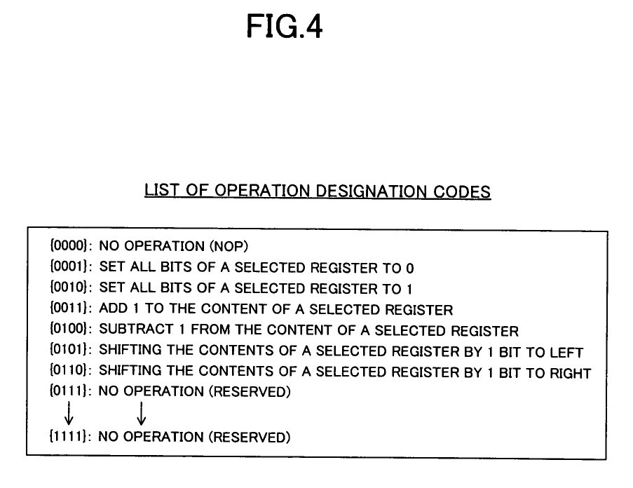

The operation designation codes included in the above command sets will be described with reference to FIG. 4. FIG. 4 shows an example of a list of the operation designation codes attached to the command codes of FIG. 3, which indicates contents of operations corresponding to the operation designation codes of four bits. The operation designation codes defined in FIG. 4 includes an operation designation code {0000} representing no operation (NOP), and six types of operation designation codes for the contents of selected registers including operation designation codes {0001} and {0010} for setting all bits of the selected register to 0/1, operation designation codes {0011} and {0100} for adding/subtracting 1 to/from the content of a selected register, and operation designation codes {0101} and {0110} for shifting the content of a selected register by one bit to left/right. Since operation designation codes larger than or equal to {0111} are defined as NOP (reserved) in the example of FIG. 4, the content of each operation designation code is substantially specified by lower three bits thereof. It is possible to configure a flag, a counter, a status register or the like by using the above operation designation codes in the register file 12 and the operation circuit 13.

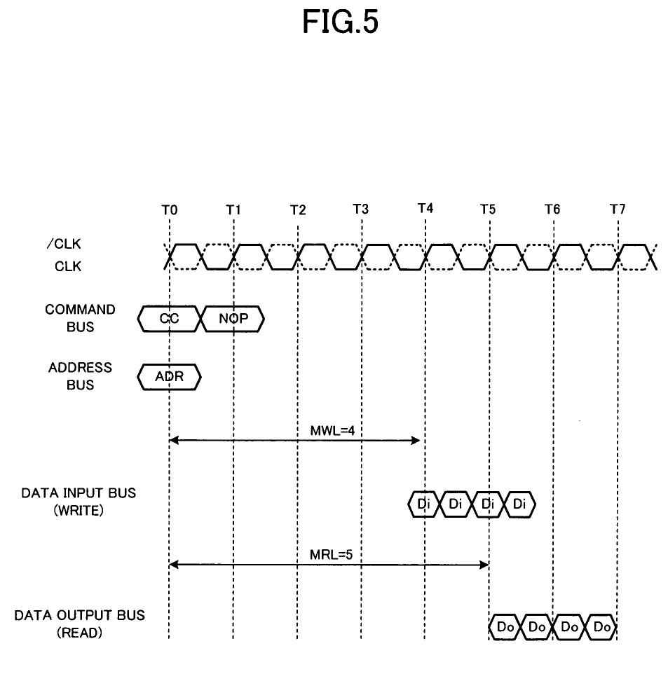

Write and read operations in the memory system 1 of the embodiment will be described with reference to FIGS. 5 to 7. FIG. 5 shows operation waveforms when the memory cell array 11 is accessed in the memory system 1. There are shown waveforms within a predetermined time range, which are related to respective transmission data of a clock CLK and an inverted clock /CLK, the command bus B1, the address bus B2, the data input bus B3 and the data output bus B4 respectively from the upper part of FIG. 5. Operations in the memory system 1 of the embodiment are controlled in synchronization with the clock CLK and the inverted clock /CLK of a predetermined period in the same manner as, for example, DDR-SDRAM.

In a write operation for the memory cell array 11, a predetermined command code CC and an operation designation code NOP are received from the command bus B1 in time division, and sent to the command decoder 16 and the operation designation decoder 17 respectively through the demultiplexer 15. Further, a memory cell array address ADR is received from the address bus B2, and sent to the address decoder 20 through the demultiplexer 19. Then, after a memory write latency MWL is elapsed from timing T0, data Di is received from the data input bus B3, and writing for a selected address in the memory cell array 11 is performed. As shown in FIG. 5, since the data Di is inputted from timing T4, MWL=4 is satisfied.

Next, In a read operation for the memory cell array 11, a predetermined command code CC and an operation designation code NOP are received from the command bus B1 in time division, and a memory cell array address ADR is received from the address bus B2, in accordance with the same control as in the write operation. Then, after a memory read latency MRL is elapsed from timing T0, reading for a selected address in the memory cell array 11 is performed, and data Do is outputted from the data output bus B4. As shown in FIG. 5, since the data Do is outputted from timing T5, MRL=5 is satisfied.

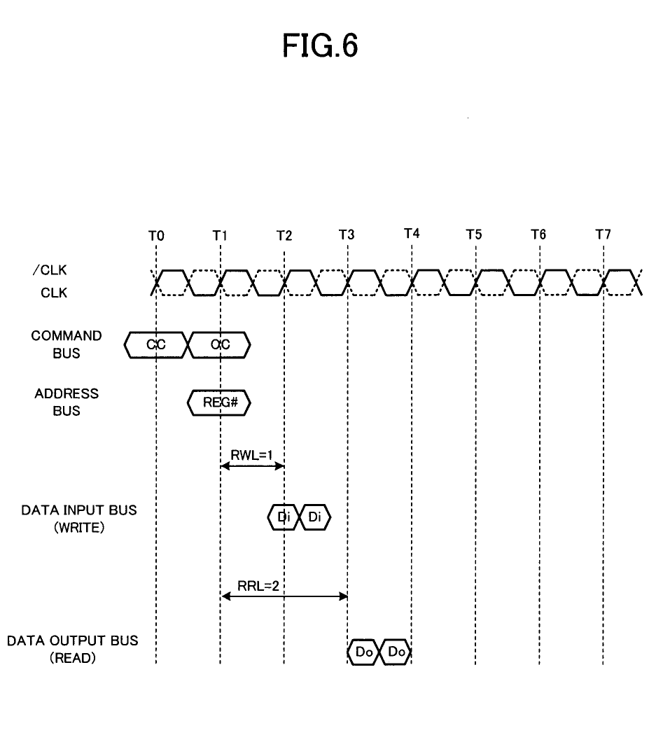

FIG. 6 shows operation waveforms when the register file 12 is accessed in the memory system 1. There are shown waveforms within the same time range as in FIG. 5, which are related to respective transmission data of the clock CLK and the inverted clock /CLK, the command bus B1, the address bus B2, the data input bus B3 and the data output bus B4 respectively from the upper part of FIG. 6.

In a write operation for the register file 12, a predetermined command code CC and a predetermined operation designation code OC are received from the command bus B1 in time division, and sent to the command decoder 16 and the operation designation decoder 17 respectively through the demultiplexer 15. Further, a register number REG# is received from the address bus B2, and sent to the register designation decoder 21 through the demultiplexer 19. Then, after a register write latency RWL is elapsed from timing T1, data Di is received from the data input bus B3, and writing for a register of the register number REG# in the register file 12 is performed. As shown in FIG. 6, since the data Di is inputted from timing T2, RWL=1 is satisfied.

Next, in a read operation for the register file 12, a predetermined command code CC and an operation designation code OC are received from the command bus B1 in time division, and a register number REG# is received from the address bus B2, in accordance with the same control as in the write operation. Then, after a register read latency RRL is elapsed from timing T1, reading for a register of the register number REG# in the register file 12 is performed, and data Do is outputted from the data output bus B4. As shown in FIG. 6, since the data Do is outputted from timing T3, RRL=2 is satisfied.

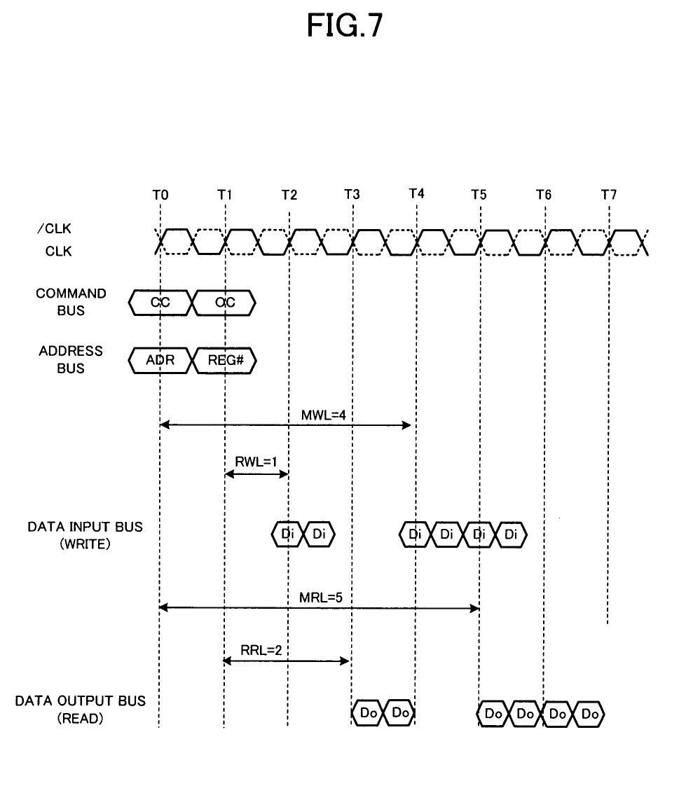

FIG. 7 shows operation waveforms when the memory cell array 11 and the register file 12 are accessed simultaneously in the memory system 1. There are shown waveforms within the same time range as in FIGS. 5 and 6, which are related to respective transmission data of the clock CLK and the inverted clock /CLK, the command bus B1, the address bus B2, the data input bus B3 and the data output bus B4 respectively from the upper part of FIG. 7.

In a write operation, a predetermined command code CC and a predetermined operation designation code OC are received from the command bus B1 in time division, and sent to the command decoder 16 and the operation designation decoder 17 respectively through the demultiplexer 15. Further, a memory cell array address ADR and a register number REG# are received from the address bus B2 in time division, and sent to the address decoder 20 and the register designation decoder 21 respectively through the demultiplexer 19. Then, after the memory write latency MWL as in FIG. 5 and the register write latency RWL as in FIG. 6 are elapsed, data Di is received from the data input bus B3 in time division. The data Di is extracted by the demultiplexer 22 and writings for a selected address in the memory cell array 11 and a register of the register number REG# in the register file 12 are performed respectively. As shown in FIG. 7, MWL=4 and RWL=1 are satisfied similarly as in FIGS. 5 and 6.

In a read operation, a predetermined command code CC and a predetermined operation designation code OC are received from the command bus B1 in time division, and a memory cell array address ADR and a register number REG# are received from the address bus B2 in time division, in accordance with the same control as in the write operation. Then, after the memory read latency MRL as in FIG. 5 and the register read latency RRL as in FIG. 6 are elapsed, readings for a selected address in the memory cell array 11 and a register of the register number REG# in the register file 12 are performed respectively. The read data are combined in the multiplexer 24 and outputted as data Do from the data output bus B4 in time division. As shown in FIG. 7, MRL=5 and RRL=2 are satisfied as in FIGS. 5 and 6.

By comparing the respective latencies MWL, RWL, MRL and RRL in FIG. 7, it is understood that the time required for accessing a register in the register file 12 is shorter than the time required for accessing a memory cell in the memory cell array 11. This is a reflection of the fact that the memory cell array 11 has a large capacity of 2 G Byte while the register file 12 has a small capacity of 16 word×16 bits. Thus, access latencies (RWL and RRL) for the register file 12 can be set to smaller values than access latencies (MWL and MRL) for the memory cell array 11. Thereby, as shown in the upper part of FIG. 7, write data for the register file 12 can be received through the data input bus B3 before write data for the memory cell array 11 is received, in the write operation. Further, as shown in the lower part of FIG. 7, read data from the register file 12 can be outputted through the data output bus B4 before read data from the memory cell array 11 is outputted, in the read operation.

As described above, the memory system 1 of the embodiment enables a smooth process when simultaneously accessing the memory cell array 11 and the register file 12 through a common bus, by utilizing a difference of access latencies thereof. Thus, in a case where required common information is stored in the register file 12 and data for information processing is stored in the memory cell array 11, it is possible to transfer data without independently accessing each of the memory cell array 11 and the register file 12, so that unnecessary access operation can be prevented. Further, by employing the configuration of the embodiment, the conventional bus configuration of the memory system 1 can be used without being modified, new buses are not required to be added, and an increase in area due to new additional circuits and the like can be avoided, so that the above effect can be obtained with low cost.

In the configuration of the memory system 1 shown in FIG. 1, a case has been described in which the data input bus B3 and the data output bus B4 are provided separately, however a configuration in which these buses are combined to share a data input/output bus may be employed. By this configuration, the number of pins of a package for a chip in a memory system can be reduced, thereby reducing the package cost. Besides, a configuration in which the memory system 1 is a constituent element in a computer system will be described later.

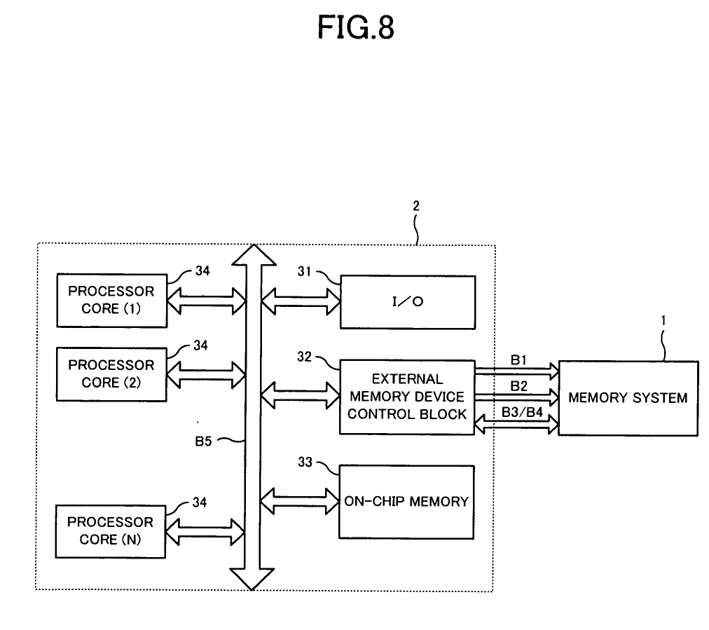

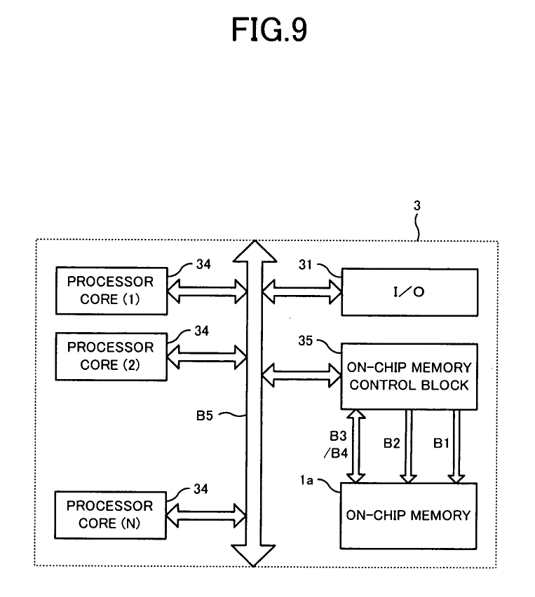

Next, a computer system including the memory system 1 of the embodiment will be described with reference to FIGS. 8 and 9. FIG. 8 is a block diagram showing a first example of the computer system including the memory system 1 of the embodiment. In the computer system corresponding to the first example, there is provided a multi-core processor 2 including an interface portion 31, an external memory device control block 32, an on-chip memory 33, N processor cores 34 represented as cores (1) to (N), and a bus B5 for connecting these elements. This multi-core processor 2 is formed on a single chip, and the memory system 1 of the embodiment is separately formed on another chip.

In the multi-core processor 2 of FIG. 8, an access to the memory system 1 is controlled by the external memory device control block 32. Each of the above-mentioned command bus B1, the address bus B2, the data input bus B3 and the data output bus B4 connects between the external memory device control block 32 and the memory system 1. In this manner, the memory system 1 functions as an external memory device in the computer system of the first example.

FIG. 9 is a block diagram showing a second example of the computer system including the memory system 1 of the embodiment. In the computer system corresponding to the second example, there is provided a system-on-chip 3 including an interface portion 31, an on-chip memory control block 35, an on-chip memory 1a composed of the memory system 1 of the embodiment, N processor cores 34 represented as cores (1) to (N), and the above-mentioned buses B1 to B5 for connecting these elements. This system-on-chip 3 is formed on a single chip.

In the system-on-chip 3 of FIG. 9, the on-chip memory 33 of FIG. 8 is replaced with the on-chip memory la as the memory system 1, and an access to the on-chip memory 1a is controlled by the on-chip memory control block 35. Each of the above-mentioned command bus B1, the address bus B2, the data input bus B3 and the data output bus B4 connects between the on-chip memory control block 35 and the on-chip memory 1a. In this manner, the memory system 1 functions as an on-chip memory device in the computer system of the second example so that the entire system is formed on the same chip.

In addition, an operating system capable of handling a plurality of threads is desired to be installed in the computer system having the configuration of FIG. 8 or 9. Since the common information required in parallel processing of such an operating system is stored in the register file 12 according to the above-mentioned operation, a decrease in process efficiency when accessing the common information can be effectively prevented.

It is apparent that the present invention is not limited to the above embodiments, but may be modified and changed without departing from the scope and spirit of the invention.

What is claimed is:

1. A memory system comprising:
a memory cell array for storing data; and
a register unit including one or more registers for storing system information,
wherein when a simultaneous access to the memory cell array and the register unit is requested, write data for the memory cell array is inputted after write data for the register unit is inputted, respectively through a common data input bus in a write operation, and read data from the memory cell array is outputted after read data from the register unit is outputted, respectively through a common data output bus in a read operation.

2. The memory system according to claim 1, wherein each operation of the memory cell array and the register unit is controlled based on a command code received from a command bus.

3. The memory system according to claim 2, further comprising an operation circuit for performing predetermined operations using the information stored in the register unit based on an operation designation code attached to the command code.

4. The memory system according to claim 1, wherein a memory cell to be accessed in the memory cell array is designated based on an address received from an address bus, and a register to be accessed in the register unit is designated based on register designation information received from the address bus.

5. A control method of a memory system having a memory cell array for storing data and a register unit including one or more registers for storing system information, comprising the steps of:
setting a state in an operation mode for accessing the memory cell array and the register unit simultaneously;
inputting write data for the memory cell array after inputting write data for the register unit, respectively through a common data input bus when performing a write operation; and
outputting read data from the memory cell array after outputting read data from the register unit, respectively through a common data output bus when performing a read operation.

6. The control method of a memory system according to claim 5, wherein an operation mode for accessing the memory cell array and the register unit simultaneously and an operation mode for accessing either of the memory cell array or the register unit can be selectively set.

7. The semiconductor memory device according to claim 6, wherein, when setting each of the operation modes, a read or write operation for the memory cell array and the register unit is designated in response to a command code, and each of predetermined operations using information stored in the register unit is designated to be performed in response to an operation designation code attached to the command code.

8. The semiconductor memory device according to claim 7, wherein the predetermined operations designated in response to the operation designated code includes an operation for setting all bits of a selected register to 0 or 1.

9. The semiconductor memory device according to claim 7, wherein the predetermined operations designated in response to the operation designated code includes an operation for adding/subtracting 1 to/from a content of a selected register.

10. The semiconductor memory device according to claim 7, wherein the predetermined operations designated in response to the operation designated code includes an operation for shifting a content of a selected register by one bit to left or right.

11. A computer system comprising:
the memory system according to claim 1; and
a multi-core processor including a plurality of processor cores and a control block for controlling an access to the memory cell array and the register unit respectively through a bus.

12. The computer system according to claim 12, wherein the memory system and the multi-core processor are formed on a same semiconductor chip.

13. The computer system according to claim 11, wherein an operating system for controlling each operation of the memory system and the multi-core processor is installed.

14. The computer system according to claim 13, wherein the operating system handles a plurality of threads simultaneously.
